(19) United States
(12) Patent Application Publication
(10) Pub. No.: US 2012/0090452 A1
(43) Pub. Date: Apr. 19, 2012

(54) BALLISTIC PANEL WITH CONFIGURABLE SHIELDING

(76) Inventor: Ashok Em Sudhakar, Las Vegas, NV (US)

(21) Appl. No.: 12/905,900

(22) Filed: Oct. 15, 2010

(51) Int. Cl. F41H 5/04; B32B 38/00; E05B 65/20

(52) U.S. Cl. 89/36.02; 70/237; 156/245; 89/904; 89/914; 89/910

(57) ABSTRACT

A ballistic panel provides protection from various munitions. The ballistic panel may be configured to conform to various contours and shapes. In this way, the ballistic panel may be used to create or replace traditional non-ballistic panels, such as those found in structures, vehicles, and device enclosures. The ballistic panel may comprise one or more layers of material including fiberglass, metal, mesh, ceramic, and natural and synthetic materials, among others. The ballistic panel may protect individuals, property, devices, and other assets from physical damage, electromagnetic radiation, and the like. The ballistic panel may be inexpensively constructed with low cost materials and manufacturing processes.

### BACKGROUND OF THE INVENTION

1. Field of the Invention

The invention relates to protective paneling and structures, and particularly to a ballistic panel having configurable shielding.

2. Related Art

In the modem world, threats to ones safety, information, and heath are commonplace. This has resulted in the development of protective structures, clothing, and other items. For example, various bullet-resistant or bulletproof vehicles, jackets/vests, and safe rooms are known to exist. These protections generally serve to protect the health and safety of individuals.

In addition, various security measures such as faraday cages and physical security such as locks are known to exist. These measures are generally configured to protect information such as by preventing unauthorized access to the information. Unfortunately, traditional protections and measures are costly limiting their accessibility to a wide audience of consumers. In addition, traditional protections and measures are readily identifiable, making them a target. Moreover, these traditional systems are focused only upon providing protection from particular threats.

From the discussion that follows, it will become apparent that the present invention addresses the deficiencies associated with the prior art while providing numerous additional advantages and benefits not contemplated or possible with prior art constructions.

### SUMMARY OF THE INVENTION

A ballistic panel is disclosed herein. The ballistic panel may be formed from layers of various materials. In general, the ballistic panel provides protection from various munitions. The ballistic panel may also have various types of electromagnetic shielding, such as mesh layers or solid layers, used to prevent electronic eavesdropping and surveillance. The various layers may be selected based on the environment or situation in which the ballistic panel is to be used. The ballistic panel may utilize at least one resin to cure into a hardened panel. In one or more embodiments, the ballistic panel may be formed to various contours and shapes to allow the panel to be used for a wide variety of applications.

The ballistic panel may have a variety of configurations. For example, in one exemplary embodiment, the ballistic panel may comprise one or more fiberglass mat layers, one or more fiberglass roving layers, one or more conductive mesh layers, one or more solid layers, or various combinations thereof. At least one resin may be used to encapsulate the fiberglass mat, fiberglass roving, and conductive mesh layers, and/or secure the solid layers to at least one other layer of the ballistic panel.

It is noted that a conductive bridge connecting the conductive mesh layers may be provided in some embodiments. In addition, a conductive stub extending outward from the ballistic panel may be included. The conductive stub may be connected to the conductive mesh layers, such as to allow the mesh layers to share a ground or other electrical connection. The various layers may comprise different or the same materials. To illustrate, the solid layers may comprise a lead sheet in some embodiments.

A mortise may be formed in at least one edge of the ballistic panel to allow the panel to be attached to other panels. Alternatively or in addition, one or more braces configured to connect the ballistic panel to another ballistic panel may be provided. It is contemplated that the ballistic panel may comprise one or more louvers configured to rotate between an open position and a closed position.

In another embodiment, the ballistic panel may comprise one or more fiberglass layers having a contour and shape configured to match that of a vehicle panel, at least one resin encapsulating the fiberglass layers and holding the fiberglass layers in the contour matching that of the vehicle panel, and one or more mounts pressed into the fiberglass layers and held in place by the resin. The mounts may be configured to secure the ballistic panel to a vehicle. A colored coating may be on at least one side of the ballistic panel.

Various elements may be incorporated into the ballistic panel. For instance, a handle may be pressed into the fiberglass layers and held in place by the resin. Alternatively or in addition, a vehicle door locking mechanism may be pressed into the fiberglass layers and held in place by the resin.

As discussed above, the ballistic panel may have layers of various configurations. For example, the ballistic panel may comprise one or more conductive mesh layers and/or one or more solid layers.

In another embodiment, the ballistic panel may comprise one or more fiberglass layers having a shape configured to form at least a portion of an enclosure for an electronic device, at least one resin encapsulating the fiberglass layers, one or more mounts pressed into the fiberglass layers and held in place by the resin. The mounts may be configured to secure one or more electronic components to the ballistic panel. One or more openings may be in the ballistic panel to create at least one access point through which the electronic components may communicate with the electronic device.

Various methods of forming a ballistic panel are also provided herein. In one exemplary embodiment, a method for forming a ballistic panel comprises placing a first material in a press, layering one or more second materials on top of the first material, and dispensing at least one resin such that the resin encapsulates the first material and the second materials.

The first material and the second materials may be formed to a mold of the press. Pressure may be applied to the first material and the second materials through the mold to form the ballistic panel. The first material and the second materials may then be removed from the press. It is noted that the mold may be built to conform to the shape and contour of a vehicle panel, enclosure panel, or other panel/structure.

It is contemplated that one or more mounts may be placed in the press. In such case, applying pressure to the first material and the second materials attaches the mounts to the ballistic panel. One or more electronic devices may be attached to the mounts.

In addition or alternatively, one or more mesh materials may be placed into the press. In such case, applying pressure includes applying pressure to the first material, the second materials, and the mesh materials through the mold. The mesh materials may be electrically conductive.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A is an exploded view of an exemplary ballistic panel;

FIG. 1B is an exploded view of an exemplary ballistic panel;

FIG. 2A is a front perspective view of an exemplary structure comprising ballistic panels;

FIG. 2B is a front perspective view of an exemplary vehicle comprising a ballistic panel;

FIG. 2C is a front perspective view of an exemplary enclosure comprising a ballistic panel;

FIG. 3A is a side view of an exemplary ballistic panel joint;

FIG. 3B is a side view of an exemplary ballistic panel joint; and

FIG. 3C is a side view of an exemplary ballistic panel joint.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The ballistic panel herein provides a protective barrier configured to stop various munitions. In general, the ballistic panel will be used to prevent a bullet or other munitions from entering a protected area. The ballistic panel may be manufactured inexpensively, and may include various types of electromagnetic and other shielding. The ballistic panel may have various strengths to resist different types of munitions. For example, the ballistic panel may be various widths or utilize various materials to protect an area from one or more types of munitions.

As will be discussed below, the ballistic panel may have configurable shielding, such as electromagnetic shielding. In one or more embodiments, materials or layers of various materials may be selected to thwart various types of electromagnetic surveillance and/or to protect against an attack utilizing various types of electromagnetic radiation or energy. It is noted that the ballistic protection provided by the ballistic panel may also be configured. For example, the number and types of materials or layers used to construct a ballistic panel may be selected based on the environment or situation in which the panel is to be used. Since, as will become apparent from the discussion below, materials may be easily incorporated into the ballistic panel's manufacturing process, a variety of protection may be provided efficiently and cost effectively.

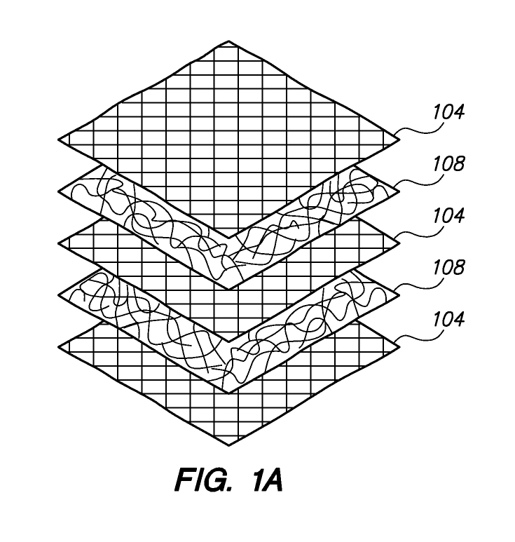

The exploded views of FIGS. 1A-1B illustrate what types of materials may be used to form the ballistic panel. It is noted that the materials shown are exemplary and that other materials may be used. Typically, the materials will be in planar or sheet form to allow the ballistic panel to be formed in layers.

FIG. 1A illustrates an exemplary ballistic panel comprising alternating layers of materials. As shown, the ballistic panel includes a fiberglass mat layer 104 or fiberglass cloth layer, and a fiberglass roving layer 108. The layers may alternate such that a different material (relative to its adjacent layers) is used for each layer. As can be seen for example, the ballistic panel in FIG. 1A is comprised of alternating layers of fiberglass mat 104 and fiberglass roving 108. Though shown with a particular number of layers, it is contemplated that fewer or additional layers of material may be provided in some embodiments. In general, the number of layers may be increased to protect from munitions of increased power or increased piercing capability.

The layers need not alternate in some embodiments. For example, there may be multiple layers of fiberglass mat 104 followed by one or more layers of fiberglass roving 108, and vice versa. Some exemplary quantities and sequences of layers include:

| Armor Level | Panel Width (in) | Composition |
|---|---|---|
| 1 | 2/16 | III/II |
| 3 | 3/16 | I/II/II/I |
| 3 | 5/16 | III/II/II/III |
| 4 | 7/16 | III/III/III/III/III |
| 5 | 9/16 | III/III/III/III/III/III |
| 7 | 9/16 | I/III/III/III/III/III/III/I |

In the examples, individual “I”s represent individual fiberglass roving layers 108 and individual “/”s represent individual fiberglass mat layers 104. The fiberglass roving 108 and fiberglass mat 104 may be various weights. For example, in the above example, the roving may be 24 oz while the mat is 1 oz. Other weights may be used as well. The panel widths are provided for illustrative purposes only. A ballistic panel may be compressed to various widths. In one or more embodiments, the panels may be 0.5 in for example.

Exemplary information regarding Armor Level is provided in the following chart.

| | | | Meets | Meets | Meets | Meets |
|---|---|---|---|---|---|---|
| | | | and | and | and | and |
| Armor | | | Exceeds | Exceeds | Exceeds | Exceeds |
| Level/Rating | Bullet | Weapon | UL752 | NIJ | British | EN1063 |
| 1 | 19 × 18 mm, | USSR/ | | | | |
| Small Arms | 94 gr., Ball | Makarov, | | | | |
| | | 9.6 cm, | | | | |
| | | 1115 fps | | | | |
| | 9 mm, 124 gr., | Smith & | I | IIA | G0 | |
| | Ball | Wesson 39, | | | | |
| | | 1175 fps | | | | |
| | 40 S&W, | Berretta 96, | | | | |
| | 180 gr., Ball | 4.9 in, | | | | |
| | | 924 fps | | | | |
| 2 | 22 LR, 40 gr., | Remington | | | | B1 |
| High Power | Lead | Bolt Action, | | | | |
| Small Arms | | 18 in, | | | | |
| | | 1255 fps | | | | |
| | 22 ACP, | Commando, | | | | |
| | 230 gr., Ball | 16 in, 950 fps | | | | |
| | 38 SPC, | Smith & | | | | |
| | 158 gr., JSP | Wesson 19, | | | | |
| | | 6 in, 915 fps | | | | |
| | 762 × 25, | USSR/China | | | | |
| | 87 gr., Ball | CZ52, | | | | |
| | | Tokarev, | | | | |
| | | 4.7 in, | | | | |
| | | 1532 fps | | | | |
| | 357 MAG, | Thompson | II | II | G1 | B3 |
| | 158 gr., JSP | Contender | | | | |
| | | 5.4 in, 1250 | | | | |
| | | fps | | | | |
| | 9 mm, 124 gr., | Beretta 92, | | IIA | | B2 |
| | Ball | 4.9 in, | | | | |
| | | 1185 fps | | | | |
| | 44 MAG, | Smith & | | | | |
| | 240 gr., JSP | Wesson 29, | | | | |
| | | 4 in, 1180 fps | | | | |
| | 38 Super, | Smith & | | | | |
| | 130 gr., Ball | Wesson 19, | | | | |
| | | 4 in, 1280 fps | | | | |
| | 12 ga, 00B | Remington | ** | | | |
| | | 870, 20 in, | | | | |
| | | 1325 fps | | | | |
| | 12 ga, 0000B | Remington | | | | |
| | | 870, 20 in, | | | | |
| | | 1250 fps | | | | |
| 3 | 9 mm, 124 gr., | Uzi, 10 in, | | | | |
| Super Power | Ball | 1280 fps | | | | |
| Small Arms | 9 mm 124 gr., | Colt AR 15, | VI | IIIA | | |
| | Ball | 16 in, | | | | |
| | | 1400 fps | | | | |
| | 44 MAG, | Thompson | III | IIIA | G2 | B4 |
| | 240 gr., SWC | Contender, | | | | |
| | | 9 in, 1350 fps | | | | |
| | 12 GA, 1 oz, | Remington | ** | | S86 | |
| | Slug | 870, 20 in, | | | | |
| | | 1585 fps | | | | |
| 4+ | 30 M-1, | M-1 | | | | |
| High Power | 80 gr., Ball | Carbine, | | | | |
| Rifle and M- | | 18.5 in, | | | | |
| 1 Carbine | | 600 m/s | | | | |
| | 7.62 × 39, | China & | | | | |
| | 124 gr., MP | USSR SKS | | | | |
| | SP | AK 47, | | | | |
| | | 20 in/16.3 in, | | | | |
| | | 735 m/s, | | | | |
| | | 710 m/s | | | | |
| | 30-06, | M-1 Garand, | IV *** | | | |
| | 180 gr., JSP | 24 in, | | | | |
| | | 2540 fps | | | | |
| 5 | 5.56, 55 gr., | Colt AR 15 | VII | | R1 | B5 |
| Super Power | Ball | Ultramatch, | | | | |
| Military | | 20 in, | | | | |
| Rifle | | 3280 fps | | | | |
| 6 | 7.62 × 51, | M1A | V **** | III | R2 | B6 |
| High | 147 gr., Ball | SOCOM, | & VIII | | | |
| Velocity | | 18 in, | | | | |
| Military | | 855 m/s | | | | |
| Rifle | 30-06, | M-1 Garand, | IV | | | |
| | 150 gr., Ball | 24 in, | | | | |
| | | 2540 fps | | | | |
| | 7.62 × 54, | SVD | | | | |
| | 148 gr., MB | Dragunov | | | | |
| | SP | (Tiger), | | | | |
| | | 20 in, | | | | |
| | | 2690 fps | | | | |
| 7 | 7.62 × 39, | SKS, | | | | |
| High Power | USSR/China, | 20 in/16.3 in, | | | | |
| High | API/AK 47 | NTK | | | | |
| Velocity | 7.62 × 51, | M1A, 20 in, | | | | B7 |
| Military | NATO, AP | NTK | | | | |
| Armor | 30-06, USA, | M-1 Garand, | | IV | | |
| Piercing & | AP | 24 in, NTK | | | | |
| Incendiary | 7.62 × 54, | SVD | | | | |
| | Russia, AP | Dragunov, | | | | |
| | | 20 in, NTK | | | | |

* behind vehicle exterior skin
** U.L. Supplementary - Shotgun (no number)
*** If box under testing agency (i.e., U.L., NIJ, etc . . .) is blank that agency has no listing for designated weapon; however, all weapons listed utilized in testing Levels 1-7.
**** one round center (not multi-hit)
fps: feet per second
m/s: meters per second
JSP: jacketed soft point
MB SP: military ball, steel penetrator
NTK: need to know
SWC: semi-wad cutter
AP: armor piercing

The fiberglass mat 104 adds strength to the panel to allow the panel to resist puncture or piercing. However, fiberglass mat 104 may be relatively expensive. The fiberglass roving 108 also adds strength but has a reduced cost. As such, it is contemplated that fiberglass roving 108 may, but need not, be used on internal layers to provide a strengthening filler layer or layers between two sides of a ballistic panel. The fiberglass roving 108 thus reduces the cost of the ballistic panel. Cost reduction is highly advantageous in that it allows the ballistic panel to be purchased and used by a wide audience of consumers. In addition, cost reduction allows an increased number of ballistic panels to be used to protect an area. For example, where a user would otherwise have to make compromises due to cost, the ballistic panels herein may allow the user to purchase enough panels to surround or provide full coverage and protection of an area. Lower cost also allows ballistic panels of higher strength to be made for purchase as compared to traditional panels.

It is noted that the fiberglass roving 108 typically will not contain a starch oil coating in one or more embodiments to hold cut strands of the roving together. This is highly advantageous in that it results in a stronger ballistic panel. The fiberglass roving 108 or fiberglass mat 104 may be made from various types of glass including E glass or S glass. It is also noted that a ballistic panel may be colored and/or finished on one or more both sides. For example, a gelcoat, polyester coat, paint, or other coating may be applied to the ballistic panel one or both sides. The coloring is highly advantageous in that it allows a molded ballistic panel or other ballistic panel to match non-ballistic structures (e.g., vehicle/structure panels and walls). In this manner, the ballistic panels cannot be readily identified and do not draw needless attention to a vehicle, structure, individual, or other protected asset.

A coating may also be used to give the surface of a ballistic panel a smooth surface. For example, a thin coating of putty, resin, bondo, or the like may be used to produce a smooth surface. In addition or alternatively, a gel coat may be used.

A ballistic panel may comprise a wide variety of materials. For example, FIG. 1B illustrates an exemplary ballistic panel having shielding in the form of a mesh layer 112 and a solid layer 116. As can be seen shielding may be used in concert with fiberglass mat 104 and fiberglass roving 108 (or other) layers. The fiberglass or other layers may provide structure, while the shielding layers shield, capture, or block electromagnetic radiation. It is noted that shielding layers may provide some structure (i.e., puncture resistance) and structural layers may provide some shielding, or vice versa in various embodiments of the ballistic panel.

The mesh layer 112 may comprise one or more metal wires or the like arranged in a grid or mesh. The mesh layer 112 may be configured to prevent electromagnetic signals from escaping from an area, thus thwarting at least some forms of electronic eavesdropping or surveillance. The mesh layer 112 may be grounded in one or more embodiments, to increase its signal capturing capabilities. It is noted that the mesh layer 112 may also protect electronics within a protected area from outside interference in the form of electromagnetic waves or energy.

The mesh layer 112 may have openings of various sizes depending on the type or frequency of electromagnetic wave to be captured or blocked. For example, there may be between 80-200 openings per square inch in some embodiments. In one embodiment 100 openings per square inch may be provided. It is contemplated that multiple mesh layers 112 may be provided in some embodiments, such as to capture or block electromagnetic energy of various frequencies or types. The multiple mesh layers 112 may be adjacent layers or may be separated by a non-mesh layer. A mesh layer 112 may be formed from one type or multiple types of metals. For example, the mesh layer 112 may be formed entirely from copper in one embodiment. In another embodiment, the mesh layer 112 may be formed with copper and another metal. It is contemplated that steel, tin, or other lower cost metals/alloys may be used to form the mesh layer 112 to reduce cost.

A solid layer 116 may be provided as well to prevent eavesdropping. For example, a solid layer of lead or other metal may be used to capture or block electromagnetic radiation such as described above with regard to the mesh layer 112. The solid layer 116 may be grounded as well. It is contemplated that the solid layer 116 may be used instead of a mesh layer 112 in some embodiments.

The solid layer 116 may also be used to prevent additional types of eavesdropping. For example, the solid layer 116 may block infrared cameras, thermal imaging, x-ray imaging, or the like to prevent a third party from viewing heat signatures within a protected area. This prevents individuals from being identified and prevents third parties from determining if the protected area is occupied and by how many people. It is contemplated that shielding layers, such as those made from a metal or conductive material, may be connected by a conductive “bridge” internal to a ballistic panel one or more embodiments. In this way, the shielding layers may all share a grounding or other connection. It is also contemplated that the shielding layers may be connected to a stub or other external connector of a ballistic panel. In this manner, the shielding layers of individual ballistic panels may be electrically connected, such as to share a common ground. Alternatively, individual ballistic panels may be grounded.

Typically, the shielding layers may be internal to a ballistic panel so as to protect its materials from the elements. For example, metal layers may corrode if exposed to the elements. Of course, the shielding layers may also be on the external surface or form the external surface of a ballistic panel, such as shown by the solid layer 116 in FIG. 1B. It is contemplated that the solid layer 116 may protect the ballistic panel in some embodiments. For example, the solid layer 116 may be a stainless steel or ballistic steel sheet or the like that protects the other layers of the ballistic panel from the environment or elements. The solid layer 116 may also be a ceramic layer that adds structure and puncture resistance.

Such layers may be of various thickness and configuration. For example, a steel layer may be hot or cold rolled and wrapped or not wrapped in ballistic fiberglass. The steel layer may be tempered, such as 450-500 Brinell tempered. Ceramic layers may have various compositions. In one embodiment, the ceramic layer comprises 85-90% aluminum oxide for example. A ceramic layer may also be made from individual ceramic tiles. A lead layer may be pure lead or a composite. In one example embodiment, a lead layer may be 1/16 in (or thicker) such as to prevent thermal imaging and/or x-ray imaging.

The layers of the ballistic panel may be formed from a variety of metals, non-metals, natural, and synthetic materials in addition to those discussed above. For example, a layer may comprise Kevlar (trademark of DuPont), Spectra, graphene, CF 50 mesh, concrete, wood, gravel, rubber, natural or synthetic fibers, alloys, and/or composites. Inexpensive or even freely available materials such as rubber from discarded tires may be incorporated into one or more layers of the ballistic panel. Such materials may be used as filler, such as to add sound or temperature insulation, thickness, or both to a ballistic panel. These materials may also provide structure and shielding depending on their characteristics. For example, concrete layers may provide at least some structural support (or puncture resistance) while metallic layers may provide at least some shielding.

Graphene, graphene composites, and the like are advantageous in that they are strong and light. In this way, layers made of graphene or graphene composites may form ballistic panels capable of spanning larger distances. This may reduce weight, such as by allowing intermediary support structures to be reduces or eliminated, while providing ballistic protection. For various structures, such as equipment enclosures or vehicle panels, such layer(s) are also beneficial in that they strengthen the ballistic panels. It is noted that other materials, such as metals, allows, carbon fiber, and composites, may also be used in like manner for their strength.

The various layers of a ballistic panel may be encapsulated and/or adhered in resin which hardens to form a finished panel. For example a fiberglass mat 104 or fiberglass roving 108 layer may be flexible until encapsulated in a resin that is allowed to set or harden. Encapsulation is beneficial in itself because it protects the materials. For example, Kevlar (or other material that may be damaged by moisture) may be protected from moisture by being encapsulated in the resin.

The resin may encapsulate various materials. For example, resin may encapsulate a mesh layer 112 in some embodiments. It is contemplated that non-metallic filler, such as fiberglass roving or matting, may be placed in or extend into the mesh openings to provide structural support at a mesh layer 112. The filler and the mesh layer 112 may then be encapsulated in resin to form a layer.

The resin may also bond layers to one another. For example, a solid layer 116 may be bonded to another layer via the resin. In this manner, the resin functions as an adhesive to connect one layer to another. It is contemplated that a solid layer 116 may be separated into smaller sections so as to allow the resin to encapsulate the solid layer as well. In addition, or alternatively, the border of the ballistic panel may extend beyond the solid layer 116 such that the solid layer may be encapsulated within the panel and resin.

During construction of a ballistic panel, it is contemplated that layers of material may be placed on top of one another. For example, alternating layers of fiberglass mat 104 and fiberglass roving 108 may be stacked on top of one another. Liquid resin may then be introduced, such that the resin permeates/encapsulates material of the individual the layers. A press may then be used to compress the layers into a thinner profile. The resin may then be allowed to set or harden before the pressure is released. Heat may be applied as well in some embodiments.

It is noted that this method of construction allows various types of materials to be easily incorporated into a ballistic panel. For example, a crumb rubber layer could be incorporated by layering a depth of crumb rubber in the press before pressure is applied. As another example, one or more mesh or solid layers of various types may be layer on top of one another quickly and easily within the press. This permits a wide variety of ballistic panels having various layer compositions to be formed quickly and cost effectively.

The pressure may be applied for a predetermined period of time depending on the resin used and/or temperature. Various amounts of pressure may be used as well. To illustrate, a panel may be formed using 100 tons of pressure for 12 minutes in some embodiments. Where heat is applied the time may be reduced. As can be seen, this permits the ballistic panels to be quickly produced, increasing volume and lowering costs. It is contemplated that fast-setting resins may be used to increase the speed of production.

Some exemplary resins include polyester resin, boatyard resin, epoxy/hardener resins, and the like. It is contemplated that the resins may be weather/moisture proof or weather/moisture resistant. For example, the resin may be marine resin in one or more embodiments. The resin may be fire retardant in one or more embodiments.

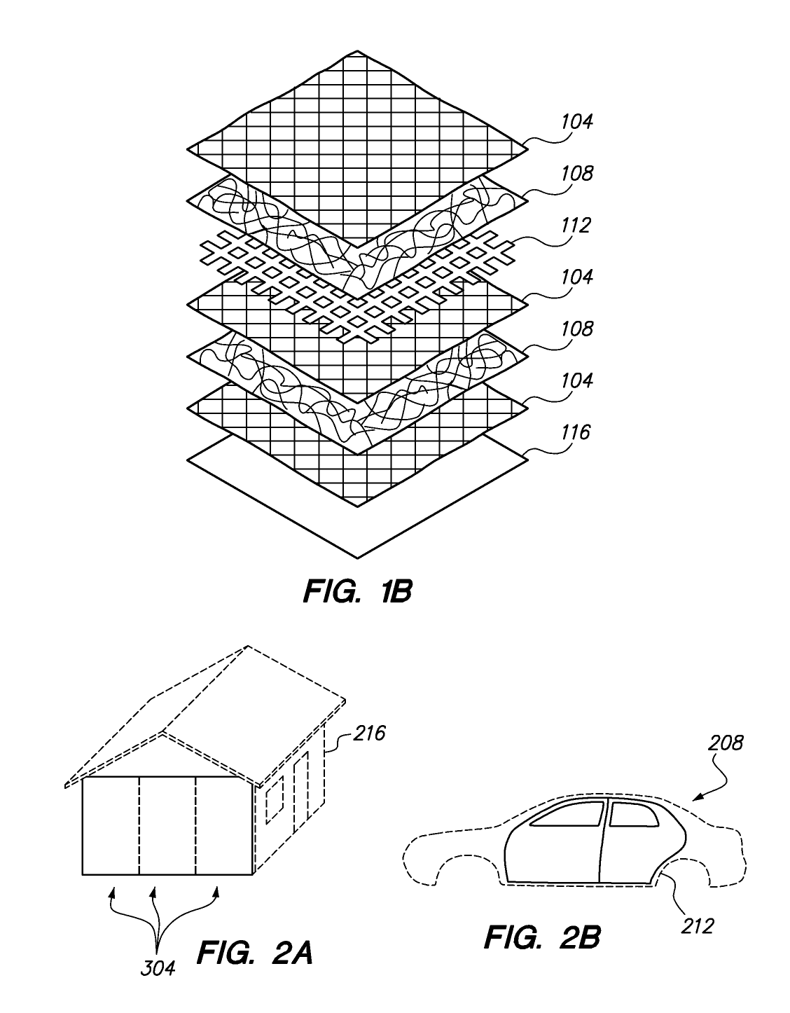

The press used to form one or more ballistic panels may have a mold or form to allow the panels to be pressed into various shapes. For example, the press may have a planer form which produces ballistic panels that a planer sheets. The form or mold may have one or more curves or angles as well, which would also be transferred to a finished ballistic panel. FIGS. 2A-2C illustrate some exemplary ballistic panels that have been formed by various molds.

FIG. 2A illustrates ballistic panels formed into planar sheets 204. As can be seen, these may be used to build safe rooms 216, shelters, and other protective structures. It is contemplated that some or all of the safe room 216 (or other structure) may be formed from ballistic panels. For example, only a portion of a safe room 216 may be formed by ballistic panels, such as in cases where the other portions of the safe room 216 are already inaccessible. For example, the sides of a safe room 216 may be adjacent a rock wall, concrete wall or another building and not require ballistic panel construction.

Some exemplary uses for a ballistic panel in construction include doors, street side (or other vulnerable side/area) of houses/buildings, ceilings, floors, roofs, shutters, safe rooms, fence or entry way façade, fencing to protect owners items (e.g, electronics, utility services, pool/spa, pets), and garage doors. The ballistic panel(s) may be angled to deflect blasts. Additional examples include door or other glass (black ballistic panels mounted to interior), reception area walls, reception desk, customer service window walls, chair backs, office doors, office desks, office walls, office ceilings, and office floors. Law enforcement and government or other agencies may also benefit from the ballistic panels. For example, ballistic panels may be used to build or in evidence rooms, radio/dispatch rooms, computer rooms, sensitive information/equipment rooms, and conference rooms.

It is noted that a ballistic panel may have one or more movable portions in some embodiments. For example, a ballistic panel door or window may be hinged or slide to open and close. A ballistic panel may have one or more louvers in some embodiments, similar to those found in shutters or window blinds. This permits a user to open a portion of the panel, such as to obtain a view of the other side of the panel, and to close the panel when desired. In addition to the view, this is advantageous in that in periods of low threat levels, the louvers may be opened and closed when a threat level is higher. As will be discussed further below, hinges, pivots, or other mechanisms which permit the louvers to move or operate may be pressed into a ballistic panel and/or attached to the panel after the panel is constructed.

FIG. 2B illustrates a ballistic panel formed into a more complex shape. As shown, the ballistic panel has been pressed or formed into a door panel 208 of a vehicle 212. This is highly advantageous in that the ballistic panel is not readily identifiable, but rather appears to be a standard door panel. In this manner, attention is not drawn to the vehicle 212 or its occupants which would potentially endanger them or allow them to be identified as a target.

By utilizing a press mold conforming to the shape of a door panel (or other complex shape), ballistic panels may be quickly and inexpensively formed into complex shapes. The ballistic panels may then be used to replace standard door panels and protect the vehicle, vehicle contents, and occupants, while appearing to be standard door panels. It is noted that a variety of vehicle panels (and other panels) may be formed in this way. For example, all the panels of a vehicle could be replaced with formed ballistic panels. In addition, internal components, such as the firewall or floor of a vehicle, could be formed with a ballistic panel. This provides a high level of protection and may be used to build protective vehicles, such as mobile ATMs, currency transporters, and the like. Alternatively, only some of the panels may be replaced, such as those surrounding the passenger compartment and/or engine compartment.

Traditionally, it is very expensive to “armor” a vehicle while preserving the vehicle's original appearance. With the press and molds used to form the ballistic panel, even complex vehicle panels of various shapes may be quickly and inexpensively formed. This provides the protection desired, while preserving the original appearance of a vehicle. In addition, since the ballistic panels may be mass produced, a large number of vehicles may be retrofitted or built with the ballistic panels.

The ballistic panel may be used in a variety of vehicles. For example, passenger, corporate, law enforcement (e.g., patrol, CSI, suspect transport vehicles), and government vehicles may have their shells at least partially constructed with ballistic panels. The vehicles need not be road vehicles. For example, panels could be formed for planes, helicopters, boats, and other vehicles. The ballistic panels may be used to protect various parts of a vehicle as stated herein. For example, the engine bay, cockpit, passenger area, or the like could be protected.

Various parts may be pressed into a ballistic panel during the forming process in one or more embodiments. For example, a hinge mechanism, locking mechanism, window opening/closing mechanism, or both could be pressed into the door panel 208 such that these mechanisms are secured to the door panel as the resin sets. In this manner, the mechanisms need not be attached later. This avoids the potential for weakening or damaging the door panel 208 that may occur should the mechanisms need to be screwed into or otherwise attached to the door panel. The parts or mechanisms pressed into a ballistic panel may vary depending on the panel type. For example a trunk panel may include one or more lights while a roof panel may not.

It is contemplated that the layers of a ballistic panel may be flexible such as to allow the layers to be pressed to conform to various shapes. Alternatively, some of the layers may be rigid and fracture under the pressure to conform to various shapes. It is contemplated that the resin encapsulation will provide a ballistic panel of desired hardness once the resin sets or cures, even where an internal layer has been fractured.

FIG. 2C illustrates a ballistic panel formed into an enclosure panel 224, such as for an ATM (automated teller machine) 220. As can be seen, the enclosure panel 224 may be formed to protect a portion of the ATM 220 (or other device having an enclosure). In the embodiment shown, only the front portion is formed with a ballistic panel. Presumably, the remainder of the ATM 220 may be buried within a wall or otherwise inaccessible to would be thieves.

As can be seen, the enclosure panel 224 may be pressed to have various shapes. In the embodiment of FIG. 2C, a lip has been formed around the edge of the enclosure panel 224. As can also be seen, the enclosure panel 224 may have various components pressed into it. For example, external components 228 or mounts therefore may be pressed into the enclosure panel 224. In this manner, the components 228 (e.g., display screen, card reader, cash dispenser) may be secured to the enclosure panel 224 without damaging or weakening the panel. Another advantage is that the enclosure panel 224 may be continuous or substantially continuous to provide better protection. For example, pressing components 228 or mounts therefore into the enclosure panel 224 allows the enclosure panel to extend behind these components preventing a breach of the enclosure at the components. The components may be connected to the ATM 220 by small electrical or physical conduits/channels. The small size of these conduits/channels makes accessing the money within the ATM 220 difficult even if the external components 228 were somehow removed.

It is noted that one or more openings could be formed in a ballistic panel to allow various components or parts to be secured to the panel in some embodiments. The openings may be formed by a mold or form. For example, in FIG. 2C, an opening may be formed for the external components 228 to allow the components to be mounted and accessible to customers.

In addition to ATMs, various other devices or objects may be enclosed partially or completely by one or more ballistic panels. For example, computer or networking equipment may be protected by enclosures formed from ballistic panels. This protects such equipment from physical damage as well as tampering. It is contemplated that storage furniture or the like may be formed from ballistic panels as well. For example, a filing cabinet, drawer, locker, or other enclosure may be formed from ballistic panels to secure and protect their contents. Transport containers for explosives, munitions, or the like may be made as well. Some additional examples, that illustrate the versatility of the ballistic panels include trauma plates, strike plates, brief case inserts, clip boards, valise inserts, fanny pack/backpack inserts, posse box inserts, entry shields, fighting shields, body armor, disrupter shields, car door inserts, and fuel tank inserts that may be formed with ballistic panels.

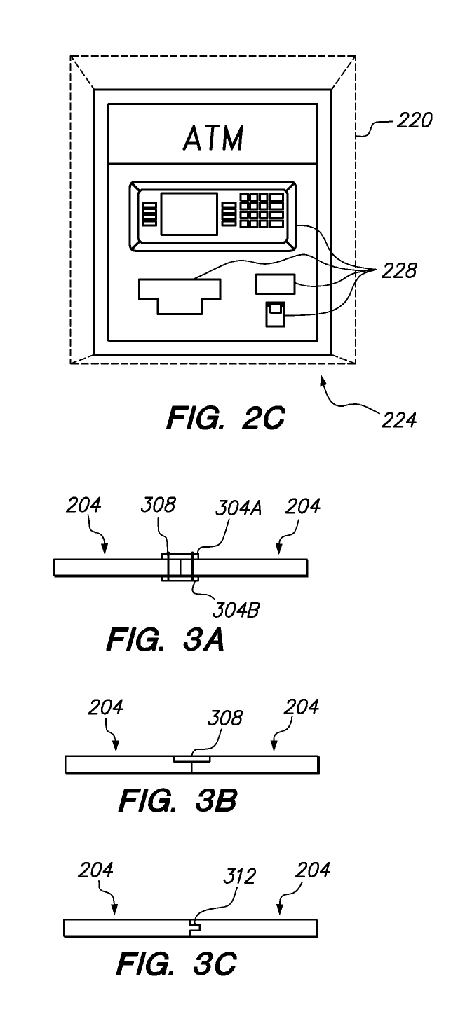

As disclosed above and illustrated in the exemplary embodiment of FIG. 2A, multiple ballistic panels may be used to enclose or protect an area. The connection between ballistic panels will now be described with regard to FIGS. 3A-3C which illustrate exemplary connections between ballistic panels. Though shown with ballistic panels in planer sheet 204 form, it is contemplated that ballistic panels of various types may be connected in the manners described in the following. The ballistic panels may also be connected in other ways. For example, in a vehicle, ATM or other device, the ballistic panels may have one or more mounts (e.g., threaded openings/connectors, brackets, plates, mating structures, etc. . . . ) like that of the panels or enclosures they are replacing. In this manner, the ballistic panels may be a “drop-in” replacement for such panels or enclosures. As stated, the mounts or mounting mechanisms may be pressed into the ballistic panels or be attached after the panels are formed.

FIG. 3A illustrates a first joint that may be used to connect ballistic panels. As can be seen, the joint may be a butt joint supported by one or more braces 304A,304B. A fastener 308 may be used to secure the braces 304A,304B to the ballistic panel sheets 204. The fastener 308 may extend a portion into a sheet 204 or may extend through the sheet. In one embodiment, the fastener 308 may extend from a first brace 304A to a second brace 304B. It is contemplated that the fastener 308 may be threaded and that the first brace 304A, second brace 304B, and/or the sheets 204 may have corresponding threaded openings.

Various fasteners 308 may be used. For example, nails or pins could be used. It is contemplated that resin, adhesive or the like may be used to further secure the fasteners to the braces 304A,304B and the sheets 204. In addition, resin, adhesive or the like may be used between the sheets 204 and the braces 304A,304B to further secure these elements together. It is contemplated that a press or clamp may be used to provide pressure as the resin or adhesive sets.

A brace 304A,304B may span the joint between ballistic panel sheets 204, such as shown in FIG. 3A. This adds strength to the joint and keeps the sheets 204 in position relative to one another. In addition, the added material improves the puncture resistance at the joint. It is contemplated that a brace 304A,304B may comprise a ballistic panel in one or more embodiments. For example, a thin ballistic panel may be used as a brace 304A,304B. Alternatively, a brace 304A,304B may be formed from other materials. These materials will typically be rigid to provide support to the joint. Some exemplary materials include metal, composites, wood, and the like.

FIG. 3B illustrates another butt joint between ballistic panel sheets 204. As can be seen, a brace 304 may be inset into the sheets 204 at the joint. In this manner, the surface at the joint is substantially flush with that of the sheets 204. As disclosed above, the brace 304 may be secured by one or more fasteners and/or resins/adhesives. Alternatively, as shown in the exemplary embodiment of FIG. 3B, only resin, adhesive, or the like may be used. For example, in FIG. 3B, resin may be between the ballistic panel sheets 204 and between the sheets and the brace 304. As with above, the brace 304 may be clamped to the sheets 204 as the resin sets or for another period of time (according to the type of resin). It is noted that the same resin used in the construction of the ballistic panel sheets 204 may be used to secure one or more braces 304 to the sheets.

FIG. 3C illustrates a mortise and tenon joint where the brace is in the form of a tenon 312 which is integral to a ballistic panel sheet 204. As can be seen, a mortise may be formed in a corresponding sheet 204. The mortise and tenon joint may be secured by resin, adhesive, or the like, such as described above. As can be seen, the mortise and tenon joint aligns and secures the ballistic panel sheets 204. It is noted that two ballistic panel sheets 204 with mortises may be joined by using a spline that may be secured within the mortises by resin, adhesive, or the like. The spline spans the joint to add strength to the joint in such embodiments.

It is contemplated that the materials and resin(s) used in the ballistic panels may be machinable, a finished ballistic panel may be machinable, or both. For example, fiberglass, metal, natural and synthetic fiber, rubber, and other materials may be machined to allow a ballistic panel to be easily shaped. In this manner, a user may form a wide variety of joints (e.g., dovetail joints, dowel joints, box joints, biscuit joints, pocket-screw joints, lap joints, miter joints, etc. . . . ). For example, in some embodiments, woodworking or metalworking (or other) tools may be used to create mortises, tenons, and the like. In addition, a user may modify the shape and or size of a ballistic panel by cutting, grinding, drilling, etc. . . . the panel. This allows the ballistic panel to be used in a wide variety of applications.

The wide variety of joints allow various ballistic panels to be connected in various ways. In this manner, a wide variety of protective structures, enclosures, and the like may be constructed. As discussed above, the ballistic panels may protect objects and living things large and small. In addition, the ballistic panels may be formed into complex shapes and/or be used as replacements for existing panels (or other structures). Moreover, the construction of the ballistic panels allows them to be made quickly and inexpensively, while allowing a great deal of customization by including or not including layers with various characteristics and properties.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A ballistic panel comprising:
one or more fiberglass mat layers;
one or more fiberglass roving layers;
one or more conductive mesh layers; and
at least one resin encapsulating the one or more fiberglass mat, fiberglass roving, and conductive mesh layers, and securing the one or more solid layers to at least one other layer of the ballistic panel.

2. The ballistic panel of claim 1 further comprising a conductive bridge connecting the one or more conductive mesh layers.

3. The ballistic panel of claim 1 further comprising a conductive stub extending outward from the ballistic panel, the conductive stub connected to the one or more conductive mesh layers.

4. The ballistic panel of claim 1 further comprising one or more solid layers, wherein the one or more solid layers comprise a lead sheet.

5. The ballistic panel of claim 1 further comprising a mortise formed in at least one edge of the ballistic panel.

6. The ballistic panel of claim 1 further comprising one or more braces configured to connect the ballistic panel to another ballistic panel.

7. The ballistic panel of claim 1 further comprising one or more louvers, the louvers configured to rotate between an open position and a closed position.

8. A ballistic panel comprising:
one or more fiberglass layers having a contour and shape configured to match that of a vehicle panel;
to at least one resin encapsulating the one or more fiberglass layers, and holding the one or more fiberglass layers in the contour matching that of the vehicle panel; and
one or more mounts pressed into the one or more fiberglass layers and held in place by the at least one resin, the one or more mounts configured to secure the ballistic panel to a vehicle.

9. The ballistic panel of claim 8 further comprising a colored coating on at least one side of the ballistic panel.

10. The ballistic panel of claim 8 further comprising a handle pressed into the one or more fiberglass layers, the handle held in place by the at least one resin.

11. The ballistic panel of claim 8 further comprising a vehicle door locking mechanism pressed into the one or more fiberglass layers, the vehicle door locking mechanism held in place by the at least one resin.

12. The ballistic panel of claim 8 further comprising one or more conductive mesh layers.

13. The ballistic panel of claim 8 further comprising one or more solid layers.

14. A ballistic panel comprising:
one or more fiberglass layers having a shape configured to form at least a portion of an enclosure for an electronic device;
at least one resin encapsulating the one or more fiberglass layers;
one or more mounts pressed into the one or more fiberglass layers and held in place by the at least one resin, the one or more mounts configured to secure one or more electronic components to the ballistic panel.

15. The ballistic panel of claim 13, further comprising one or more openings in the ballistic panel configured to create at least one access point through which the one or more electronic components may communicate with the electronic device.

16. A method of forming a ballistic panel comprising:
placing a first material in a press;
layering one or more second materials on top of the first material;
dispensing at least one resin such that the resin encapsulates the first material and the one or more second materials;
forming the first material and the one or more second materials to a mold of the press;
applying pressure to the first material and the one or more second materials through the mold; and
removing the first material and the one or more second materials from the press.

17. The method of claim 15 further comprising placing one or more mounts in the press, wherein applying pressure to the first material and the one or more second materials attaches the one or more mounts to the ballistic panel.

18. The method of claim 16 further comprising attaching one or more electronic devices to the one or more mounts.

19. The method of claim 15 further comprising placing one or more mesh materials into the press, the mesh materials being electrically conductive, wherein pressure is applied to the first material, the one or more second materials, and the one or more mesh materials through the mold.

20. The method of claim 15 further comprising forming the mold to conform to the shape and contour of a vehicle panel.
